(19) United States
(12) Patent Application Publication
(10) Pub. No.: US 2015/0308545 A1
(43) Pub. Date: Oct. 29, 2015

(54) ORBITAL TENSIONER

(71) Applicant: THE GATES CORPORATION, Denver, CO (US)

(72) Inventors: JOHN HARVEY, Novi, MI (US); Oliver Stegelmann, Strathroy (CA); Arnaud Martinez, Aachen (DE); Jochen Dilthey, Aachen (DE); Casper Haenbeukers, Landgraag (NL)

(73) Assignee: THE GATES CORPORATION, Denver, CO (US)

(21) Appl. No.: 14/263,853

(22) Filed: Apr. 28, 2014

(51) Int. Cl. F16H 7/12; F02B 67/06

(52) U.S. Cl. CPC F16H 7/1218; F02B 67/06; F16H 2007/081

(57) ABSTRACT

An orbital tensioner comprising a base, a carrier engaged with the base and revolvable about an axis A-A, a first pulley journalled to the carrier, a pivot arm mounted to the carrier, the pivot arm pivotable about an axis B-B, a second pulley journalled to the pivot arm, the axis B-B is orbitally movable about axis A-A, a spring engaged between the carrier and the pivot arm, and a damping mechanism frictionally engaged between the carrier and the base to damp a carrier movement.

### FIELD OF THE INVENTION

The invention relates to a tensioner, and more particularly, to an orbital tensioner having a carrier engaged with a base and revolvable about a first axis, a pivot arm mounted to the carrier, the pivot arm pivotable about a second axis, the second axis orbitally movable about the first axis.

### BACKGROUND OF THE INVENTION

Belt tensioners are used to impart a load on a belt. Typically the belt is used in an engine application for driving various accessories associated with the engine. For example, an air conditioning compressor and alternator are two of the accessories that may be driven by a belt drive system. A belt tensioner may include a pulley journalled to an arm which is pivotable on a base. A spring is connected between the arm and a base. The spring may also engage a damping mechanism. The damping mechanism may include frictional surfaces in contact with each other. The damping mechanism damps an oscillatory movement of the arm caused by operation of the belt drive. This in turn enhances a belt life expectancy and the tensioner life expectancy, by minimizing wear on movable components.

Dual tensioners have been applied to single belt drives which have load reversals, such as starter-generator applications, in order to tension either or both of two spans of the same belt. Since such tensioners work in concert on a single belt, they typically have a single torsion spring. Market demands can include reduction of emissions and increases in fuel economy by lowering the weight of the automobile and reducing the number of under-the-hood components. An approach taken toward these goals involves combining the function of the starter motor and the function of the alternator into a single device, a motor/generator or a gen-star. Also toward the goal of increasing fuel economy, the gen-star promotes the use of a feature called “stop-in-idle”. This feature is where the engine is allowed to die when it would ordinarily idle, then be restarted when the automobile is expected to resume motion. This feature substantially increases the demands placed upon accessory belt drives. In this type of application the starter/generator is placed in mechanical communication with the crankshaft via the accessory belt drive.

Representative of the art is EPO patent no. 2128489B1 which discloses a belt tensioning device for a belt drive which comprises a driving machine with a driving belt pulley drivable by a driveshaft around a driving axis, and a plurality of further belt pulleys, and with an infinite belt which is wrapped around the driving belt pulley and the further belt pulleys, wherein the belt tensioning device comprises a housing in which two tensioning arms are supported so as to be pivotable around a common pivot axis, in which tensioning arms there are supported tensioning rollers with axes of rotation extending parallel to the driving axis, wherein the tensioning arms are supported relative to one another by spring means, wherein the housing can be mounted, in presence of the driving belt pulley being mounted at the driving machine, in that the housing is contact-free relative to the driving machine in an annular region surrounding the driveshaft of the driving belt pulley, characterized in that the pivot axis of the tensioning arms is arranged inside the diameter of the driving belt pulley.

What is needed is an orbital tensioner having a carrier engaged with a base and revolvable about a first axis, a pivot arm mounted to the carrier, the pivot arm pivotable about a second axis, the second axis orbitally movable about the first axis. The present invention meets this need.

### SUMMARY OF THE INVENTION

The primary aspect of the invention is to provide an orbital tensioner having a carrier engaged with a base and revolvable about a first axis, a pivot arm mounted to the carrier, the pivot arm pivotable about a second axis, the second axis orbitally movable about the first axis.

Other aspects of the invention will be pointed out or made obvious by the following description of the invention and the accompanying drawings.

The invention comprises an orbital tensioner comprising a base, a carrier engaged with the base and revolvable about an axis A-A, a first pulley journalled to the carrier, a pivot arm mounted to the carrier, the pivot arm pivotable about an axis B-B, a second pulley journalled to the pivot arm, the axis B-B is orbitally movable about axis A-A, a spring engaged between the carrier and the pivot arm, and a damping mechanism frictionally engaged between the carrier and the base to damp a carrier movement.

### BRIEF DESCRIPTION OF THE DRAWINGS

The accompanying drawings, which are incorporated in and form a part of the specification, illustrate preferred embodiments of the present invention, and together with a description, serve to explain the principles of the invention.

FIG. 1 is a front perspective view of a first embodiment.

FIG. 2 is a front perspective view of a second embodiment.

FIG. 3 is a rear perspective view of the second embodiment.

FIG. 4 is a rear perspective view of the first embodiment.

FIG. 5 is a rear elevation view of the first embodiment.

FIG. 6 is a rear elevation view of the second embodiment.

FIG. 7 is a top plan view of the first embodiment.

FIG. 8 is a top plan view of the second embodiment.

FIG. 9 is a front elevation view of the first embodiment.

FIG. 10 is a front elevation view of the second embodiment.

FIG. 11 is section 11-11 from FIG. 9.

FIG. 12 is section 12-12 from FIG. 10.

FIG. 13 is section 13-13 from FIG. 14.

FIG. 14 is a side elevation view of the first embodiment.

FIG. 15 is section 15-15 from FIG. 9.

FIG. 16 is section 16-16 from FIG. 10.

FIG. 17 is a side elevation view of the second embodiment.

FIG. 18 is a front perspective exploded view of the first embodiment.

FIG. 19 is a front perspective exploded view of the second embodiment.

FIG. 20 is a rear perspective exploded view of the second embodiment.

FIG. 21 is a rear perspective exploded view of the first embodiment.

FIG. 22 is a plan view of an alternate embodiment.

FIG. 23 is a cross-sectional view of FIG. 22.

FIG. 24 is an exploded view of the alternate embodiment in FIG. 22.

FIG. 25 is a top perspective view of the embodiment in FIG. 22.

FIG. 26 is a front view of the device on an engine.

FIG. 27 is an exploded view of an alternate embodiment.

FIG. 28 is an exploded view of an alternate embodiment.

### DETAILED DESCRIPTION OF THE PREFERRED EMBODIMENT

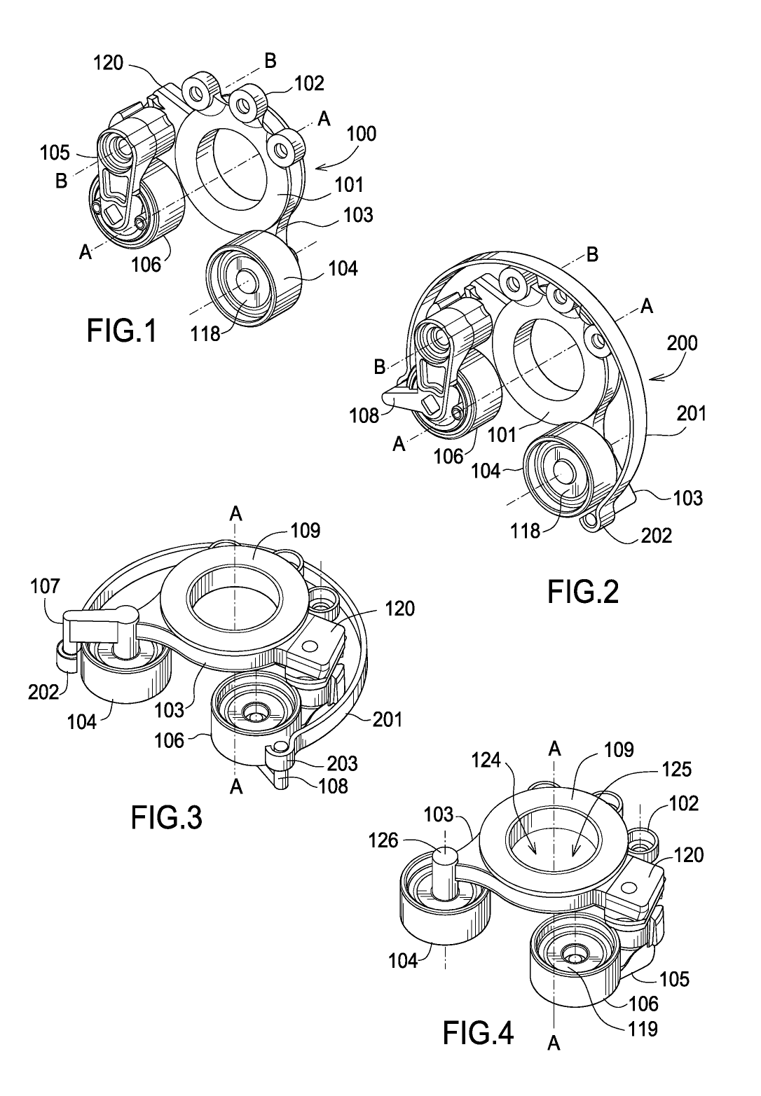

FIG. 1 is a front perspective view of a first embodiment. Tensioner 100 comprises a base 101. Base 101 comprises mounting members 102 each of which receive a fastener (not shown). The base can be mounted to a driven accessory on a vehicle engine, such as an alternator or starter-generator.

Carrier 103 is engaged with base 101 to move with a revolving motion about axis A-A. Pulley 104 is journalled to carrier 103 on bearing 118. Pulley 104 may be referred to as an idler pulley. Pulley 104 moves orbitally about axis A-A on member 103. Axis A-A does not engage or intersect any physical portion of the tensioner. Each of base 101 and carrier 103 encircle but do not intersect axis A-A. In particular, carrier 103 comprises hole 124 disposed in a plane when viewed edge-on that is coplanar with section 13-13, and which axis A-A intersects normally. Base 101 comprises hole 125 disposed in a plane when viewed edge-on that is coplanar with section 13-13, and which axis A-A intersects normally. Each of carrier 103 and base 101 encircle but do not intersect axis A-A. Hole 124 and hole 125 are coaxial and parallel.

Pivot arm 105 is pivotably connected to carrier 103 about axis B-B. Pulley 106 is journalled to pivot arm 105 on bearing 119. Axis A-A and axis B-B are parallel and are not coaxial. Pivot arm 105 and axis B-B orbit in a partial arc about axis A-A. Axis B-B is disposed a distance from axis A-A and also orbits with a constant radius (R3) about axis A-A. The range a for an orbital movement of axis B-B about axis A-A can be up to approximately 90 degrees, but is typically less than approximately 50 degrees. Radius (R1) of the rotational axis of pulley 106 to axis A-A is variable given the pivoting action of pivot arm 105 about axis B-B. Radius (R2) of the rotational axis of pulley 104 to axis A-A is constant. The rotational axis of pulley 104 and the rotational axis of pulley 106 are both disposed within an outside diameter (D) of the base, thereby rendering the tensioner very compact.

FIG. 2 is a front perspective view of a second embodiment. A second embodiment 200 further comprises a spring 201. Spring 201 comprises less than one full coil, typically limited to between 180 degrees to 270 degrees between end 202 and end 203. Spring 201 is engaged between carrier 103 and pivot arm 105. End 202 engages member 107. End 203 engages member 108. Spring 201 urges pulley 104 toward pulley 106.

FIG. 3 is a rear perspective view of the second embodiment. Spring 201 engages member 107 on carrier 103 and member 108 on pivot arm 105. Cover 109 encloses the interior of the tensioner to prevent entry of debris.

FIG. 4 is a rear perspective view of the first embodiment. Pulley 104 and pulley 106 engage a belt (not shown), for example on a vehicle engine accessory drive. The belt would be routed from a crankshaft to a driven accessory such as an alternator. Pivot arm 105 is mounted to carrier 103 upon a mounting portion 120.

FIG. 5 is a rear elevation view of the first embodiment. Axis A-A is parallel and is not coaxial with axis B-B. The clamping force of spring 201 is sufficient to keep it attached to member 107 and member 108.

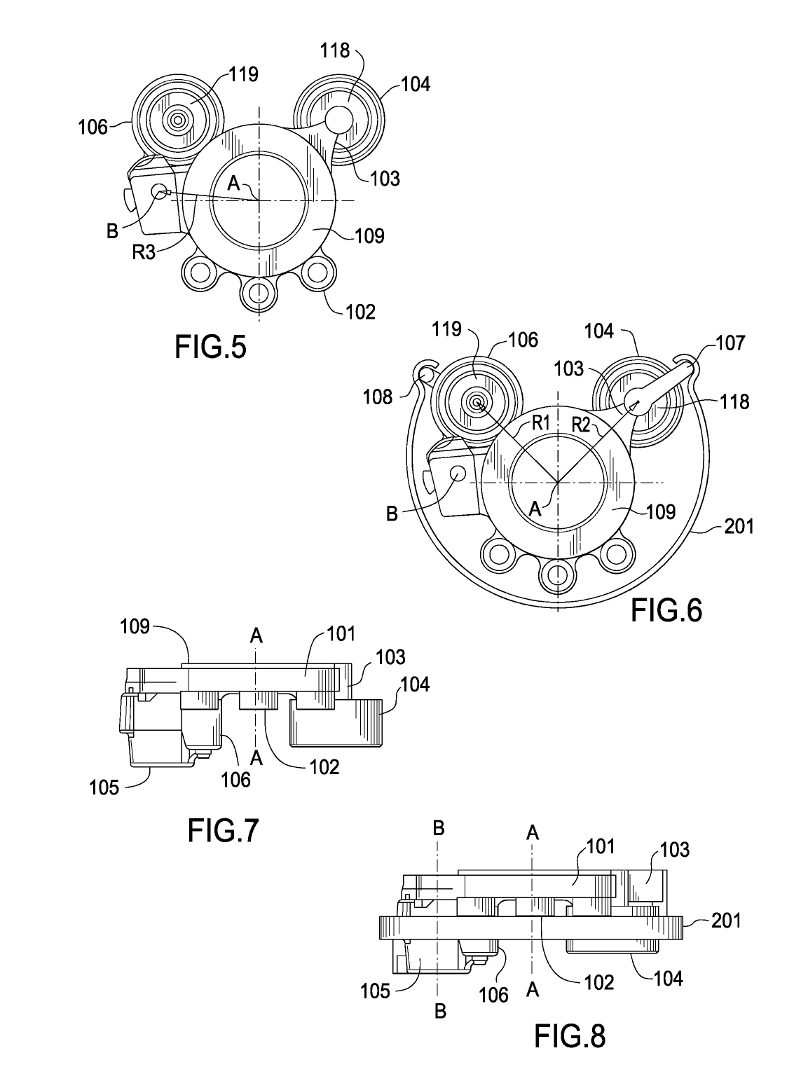

FIG. 6 is a rear elevation view of the second embodiment. Three mounting members 102 provide flexibility for attaching the device to different styles of alternators, for example. Fasteners such as bolts (not shown) can be used.

FIG. 7 is a top plan view of the first embodiment.

FIG. 8 is a top plan view of the second embodiment.

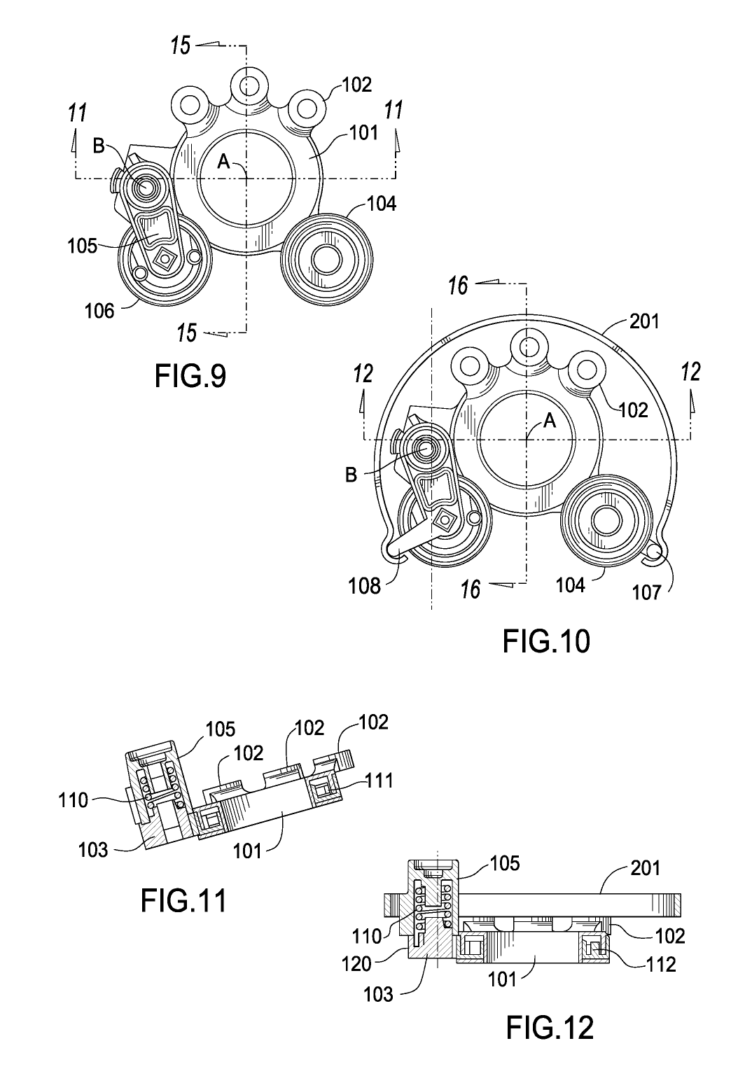

FIG. 9 is a front elevation view of the first embodiment.

FIG. 10 is a front elevation view of the second embodiment.

FIG. 11 is section 11-11 from FIG. 9. Torsion spring 110 biases pivot arm 105 and pulley 106 toward pulley 104. The combination of pivot arm 105, pulley 106 and spring 110 may also be referred to as a tensioner.

Damping mechanism 111 is enclosed between base 101 and cover 109. Damping mechanism 111 is disposed between carrier 103 and base 101. Damping mechanism 111 damps an oscillatory movement of carrier 103 by a frictional engagement between the damping mechanism 111 and base 101. Damping mechanism 111 is fixedly attached to carrier 103 at member 112.

FIG. 12 is section 12-12 from FIG. 10. Damping mechanism 111 is connected to member 112. Member 112 holds damping mechanism 111 in a fixed position relative to carrier 103.

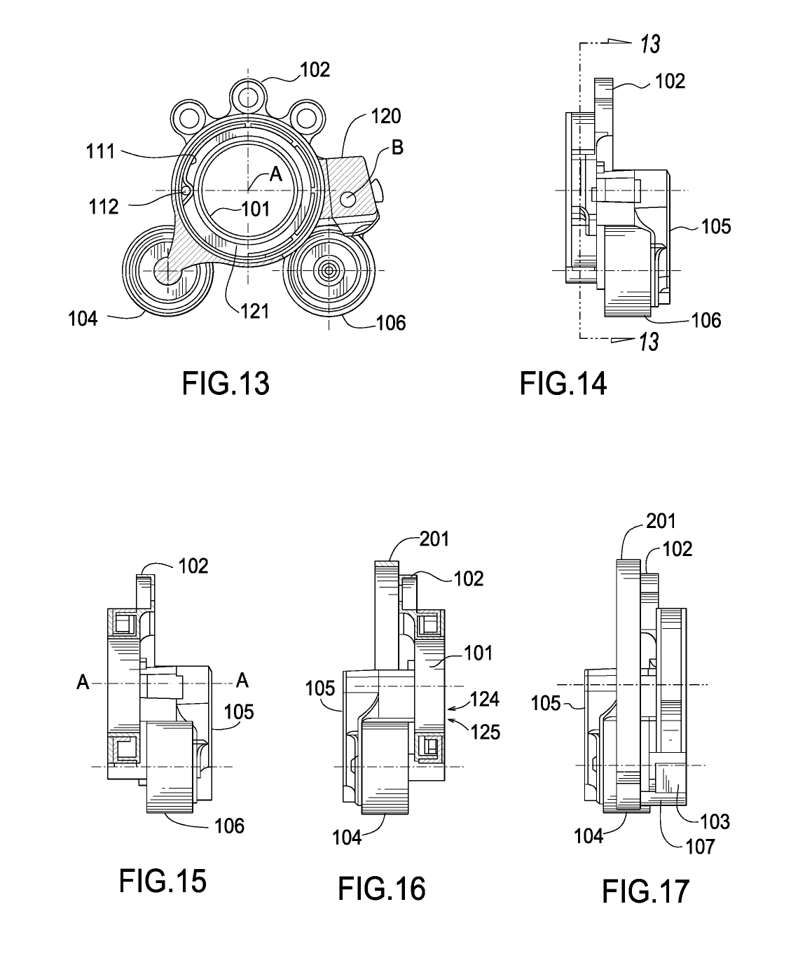

FIG. 13 is section 13-13 from FIG. 14. Damping mechanism 111 is connected to carrier 103 at mounting member 112. Damping mechanism 111 is contained within annular space 121.

FIG. 14 is a side elevation view of the first embodiment.

FIG. 15 is section 15-15 from FIG. 9.

FIG. 16 is section 16-16 from FIG. 10.

FIG. 17 is a side elevation view of the second embodiment.

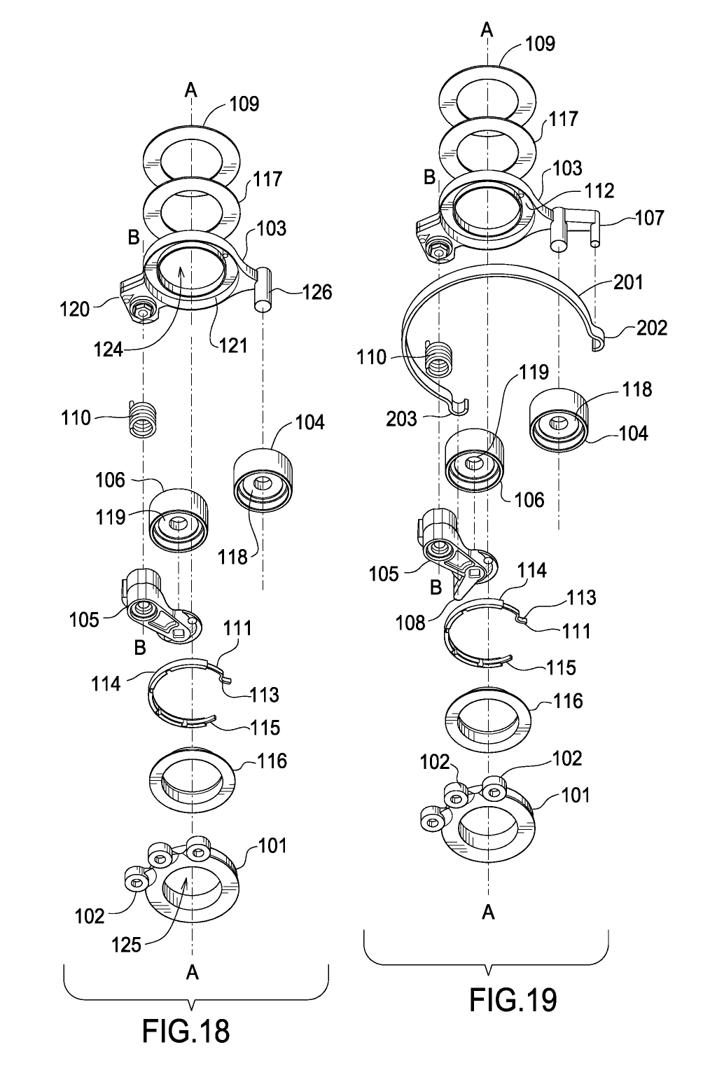

FIG. 18 is a front perspective exploded view of the first embodiment. Mounting portion 120 extends radially from carrier 103. The pivot axis of pivot arm 105 is axis B-B. The axis of rotation of carrier 103 is axis A-A. Bearing 118 is mounted to member 126. Member 126 projects from carrier 103.

FIG. 19 is a front perspective exploded view of the second embodiment. Damping mechanism 111 comprises a frictional material 114 which is attached to an arcuate spring-loaded body 115. Spring-loaded body 115 presses frictional material 114 radially outward into engagement with surface 112.

Carrier 103 engages bushing 116. Bushing 116 is disposed between carrier 103 and base 101. Bushing 117 is disposed between cover 109 and carrier 103.

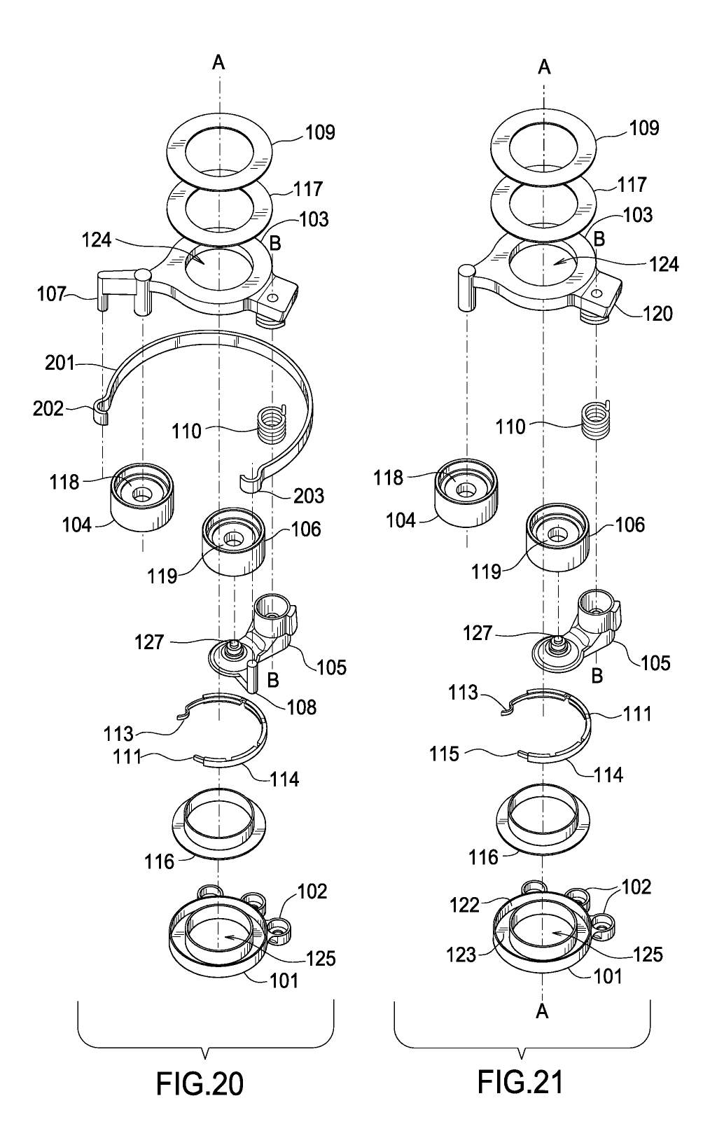

FIG. 20 is a rear perspective exploded view of the second embodiment. Bearing 119 is fastened to pivot arm 105 at member 127.

FIG. 21 is a rear perspective exploded view of the first embodiment. Frictional material 114 frictionally engages surface 122 of base 101 to damp movement of member 103. Damping mechanism 111 and carrier 103 are each disposed in annular space 123 in base 101.

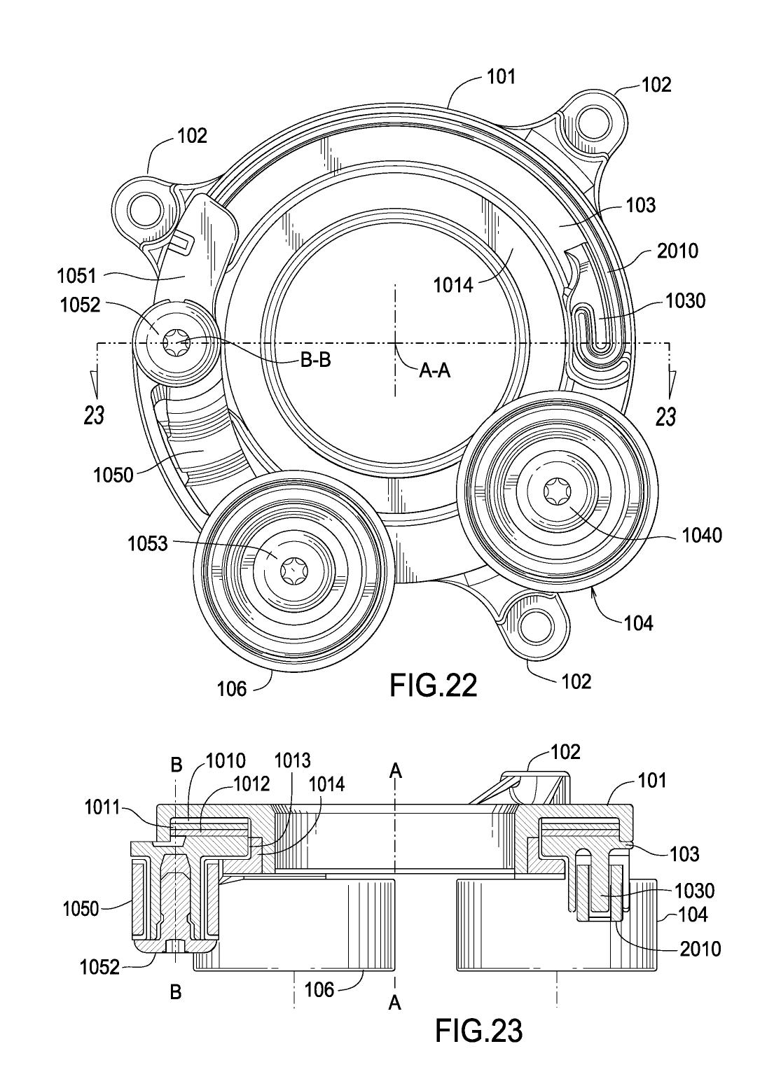

FIG. 22 is a plan view of an alternate embodiment.

In this embodiment a cantilever pivot arm 1050 is used. Spring 2010 is mounted by end 2011 to the carrier 103 mounting portion 1030. The other end 2012 of spring 2010 engages a cantilever end 1051 of pivot arm 1050. Spring 2019 urges end 1051 radially outward from axis A-A which in turn urges pulley 106 toward pulley 104, thereby loading a belt (not shown). Pivot arm 1050 pivots about bolt 1052. Retaining member 1014 holds carrier 103 in engagement with base 101.

FIG. 23 is a cross-sectional view of FIG. 22. Disposed between base 101 and carrier 103 is a spring member 1010, thrust member 1011, damping member 1012, bushing 1013 and retaining member 1014. Spring member 1010 comprises a spring washer or Belleville spring. Thrust member 1011 is engaged with base 101 so that it does not rotate with respect to base 101. Tabs 1015 engage slots 1017. Damping member 1012 is engaged with base 101 so that it does not rotate with respect to base 101. Tabs 1015 engage slots 1016.

Damping member 1012 frictionally engages carrier 103 in order to damp movements of carrier 103. Spring member 1010 provides the normal force to press damping member 1012 against carrier 103.

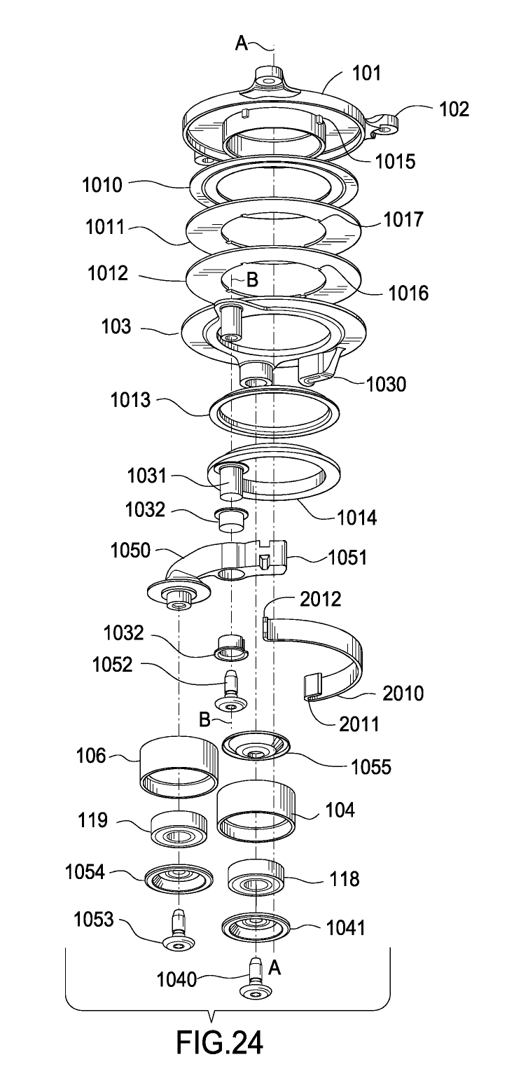

FIG. 24 is an exploded view of the alternate embodiment in FIG. 22. Bolt 1053 retains bearing 119 and pulley 106 on pivot arm 1050. Bolt 1040 retains bearing 118 and pulley 104 on carrier 103. Dust shield 1054 protects bearing 119. Dust shield 1041 protects bearing 118. Dust shield 1055 protects bearing 118. Pivot arm 1050 pivots about sleeve 1031 and bushings 1032, all retained to member 103 by bolt 1052. Axis B-B runs through bolt 1052. Bushing 1013 is disposed between retaining member 1014 and carrier 103.

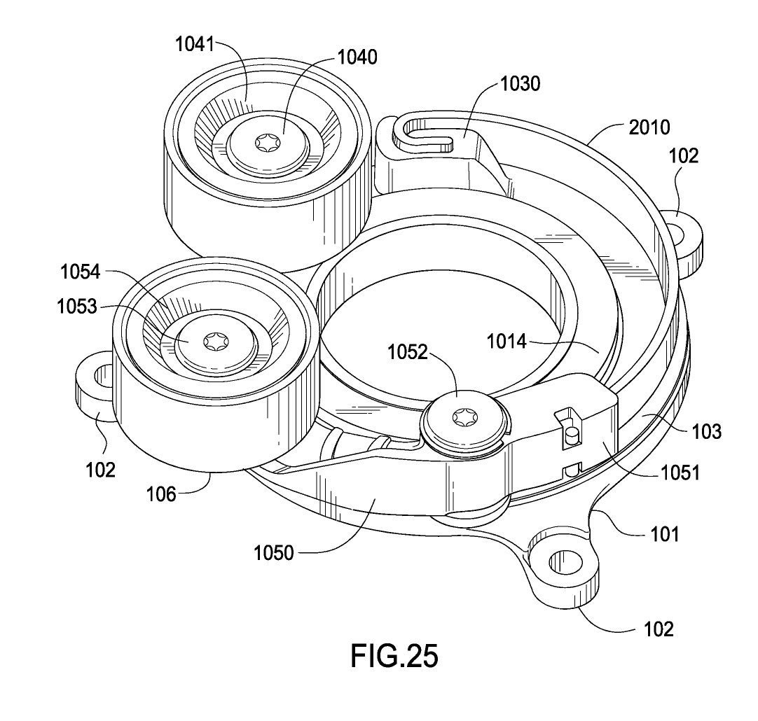

FIG. 25 is a top perspective view of the embodiment in FIG. 22. The view in FIG. 25 is opposite handed from that in FIG. 22 to illustrate the flexibility of the instant device which allows it to accommodate multiple alternator designs and engine layouts. Pivot arm 1050 is shown on the right side of the device in this Figure wherein pivot arm 1050 is shown on the left side of the device in FIG. 22. The description and function of all components are the same for all embodiments and configurations except as otherwise indicated.

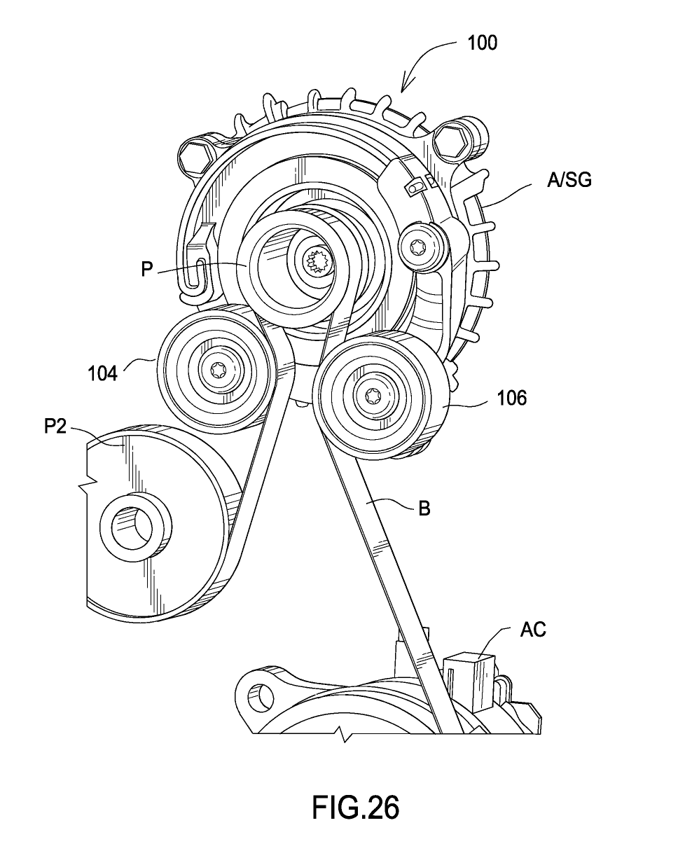

FIG. 26 is a front view of the device on an engine. Tensioner 100 is mounted to the front of a starter-generator A/SG. A belt B is routed about a starter-generator pulley P. Belt B is also engaged between pulley 104 and pulley 106. Pulley 106 presses toward pulley 104 which loads belt B. The axis of rotation of pulley P aligns with axis A-A. Other accessories driven by belt B may be present on the engine including an air conditioning compressor AC. Pulley P2 may also be connected to an engine water pump. Belt B is driven by an engine crankshaft pulley (not shown). Starter-generator A/SG may also comprise an alternator for non-stop/start applications.

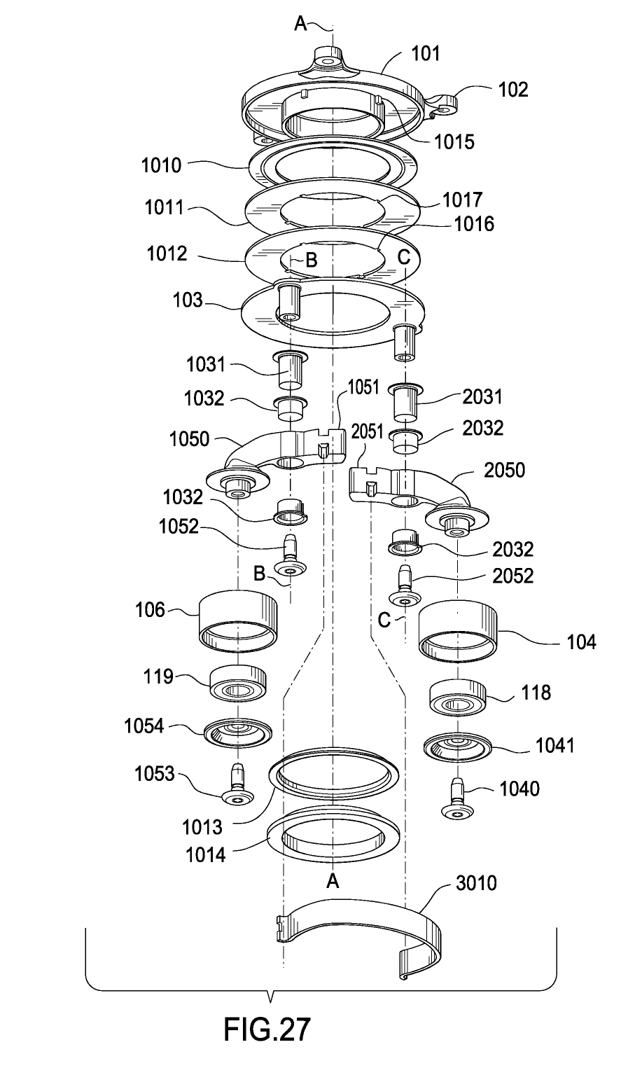

FIG. 27 is an exploded view of an alternate embodiment. The components for this embodiment correspond to those as described in FIG. 24 unless otherwise noted. Second pivot arm 2050 is pivotably mounted to carrier 103 by a bolt 2052. Pivot arm 2050 pivots about axis C-C on bushing 2031, 2032. Axis C-C is radially disposed from axis A-A. Pulley 104 is journalled to pivot arm 2050 by bearing 118. Spring 3010 is engaged between pivot arm 1050 and pivot arm 2050. Spring 3010 acts upon pivot arm 1050 and pivot arm 2050 thereby urging pulley 106 toward pulley 104, which in turn loads a belt, see FIG. 26.

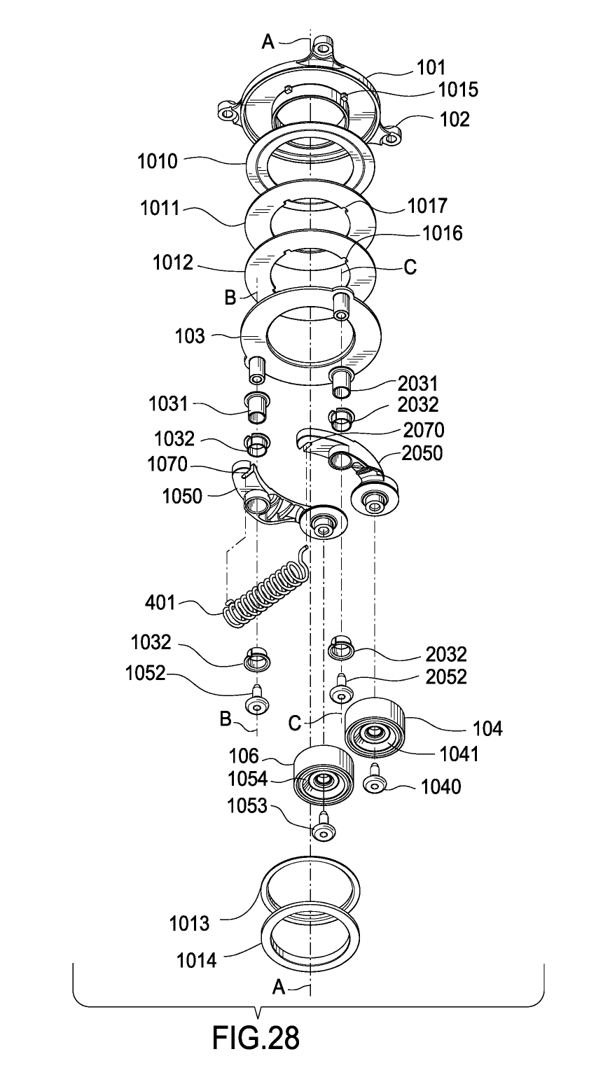

FIG. 28 is an exploded view of an alternate embodiment. The components for this embodiment correspond to those as described in FIG. 27 unless otherwise noted.

Spring 401 is engaged between pivot arm 1050 and pivot arm 2050. Ends of spring 401 engages slot 1070 and slot 2070. Spring 401 acts upon pivot arm 1050 and pivot arm 2050 thereby urging pulley 106 toward pulley 104, which in turn loads a belt, see FIG. 26. Spring 401 comprises a compression spring.

Although forms of the invention have been described herein, it will be obvious to those skilled in the art that variations may be made in the construction and relation of parts and method without departing from the spirit and scope of the invention described herein.

I claim:

1. A tensioner comprising:
a base (101);
a carrier (103) engaged with the base and revolvable about an axis A-A;
a first pulley (104) journalled to the carrier;
a pivot arm (105) mounted to the carrier, the pivot arm pivotable about an axis B-B;
a second pulley (106) journalled to the pivot arm;
the axis B-B is orbitally movable about axis A-A;
a spring (110) engaged between the carrier and the pivot arm; and
a damping mechanism (111) frictionally engaged between the carrier and the base to damp a carrier movement.

2. The tensioner as in claim 1, wherein the damping mechanism is fixedly attached to the carrier.

3. The tensioner as in claim 1, wherein the spring is a torsion spring.

4. The tensioner as in claim 1, wherein the carrier and the base each describe an annular hole which encircles axis A-A.

5. The tensioner as in claim 1 further comprising a second spring engaged between the carrier and the pivot arm.

6. A tensioner comprising:
a base;
a carrier engaged with the base and revolvable about a first axis A-A;
a first pulley journalled to the carrier;
a pivot arm pivotally mounted to the carrier about a second axis B-B;
a second pulley journalled to the pivot arm;
the second axis B-B orbitally about the first axis A-A, the second axis B-B parallel to the first axis A-A;
a spring engaged between the pivot arm and the carrier urging the first pulley toward the second pulley; and
a damping mechanism frictionally engaged between the carrier and the base to damp a first member movement.

7. The tensioner as in claim 6, wherein the damping mechanism is attached to the carrier and frictionally engaged with the base.

8. The tensioner as in claim 6, wherein the carrier and the base each describe a hole through which axis A-A projects normally to the plane of the base.

9. A tensioner comprising:
a base;
a carrier engaged with the base, the carrier revolvable about an axis A-A, a first pulley journalled to the carrier;
a pivot arm mounted to the carrier, the pivot arm pivotable about an axis B-B, a second pulley journalled to the pivot arm;
the axis B-B orbitally movable about the axis A-A;
a damping mechanism frictionally engaged between the carrier and the base to damp a member oscillation; and
a spring engaged between the carrier and the pivot arm urging the first pulley toward the second pulley.

10. The tensioner as in claim 9, wherein axis A-A is parallel to axis B-B.

11. The tensioner as in claim 9, wherein a rotational axis of the second pulley is variable with respect to axis A-A.

12. The tensioner as in claim 11, wherein a rotational axis of the first pulley is disposed at a constant radius from axis A-A.

13. The tensioner as in claim 9, wherein the base and carrier each encircle axis A-A.

14. The tensioner as in claim 9, wherein the first pulley moves orbitally about axis A-A.

15. The tensioner as in claim 9 further comprising a second spring engaged between the carrier and the pivot arm.

16. The tensioner as in claim 15, wherein the first spring comprises a torsion spring.

17. The tensioner as in claim 9, wherein the damping mechanism comprises a frictional material fixed to an arcuate spring-loaded body.

18. The tensioner as in claim 9, wherein a rotational axis of the first pulley and a rotational axis of the second pulley are both disposed within an outside diameter of the base.

19. A tensioner comprising:
a base;
a carrier engaged with the base, the carrier revolvable about an axis A-A;
an idler pulley journalled to the carrier;
a damping mechanism frictionally engaged between the carrier and the base;
a first tensioner pivotally mounted to the carrier about an axis B-B;
axis B-B is disposed a distance from axis A-A; and
a spring engaged between the carrier and the first tensioner.

20. The tensioner as in claim 19 further comprising a second spring engaged between the carrier and the first tensioner.

21. A tensioner comprising:
a base;
a carrier engaged with the base, the carrier revolvable about an axis A-A;
a damping mechanism frictionally engaged between the carrier and the base;
a first tensioner pivotally mounted to the carrier about an axis B-B;
a second tensioner pivotally mounted to the carrier about an axis C-C;
axis B-B is disposed a radial distance from axis A-A;
axis C-C is disposed a radial distance from axis A-A; and
a spring engaged between the first tensioner and the second tensioner.

22. The tensioner as in claim 21, wherein the spring comprises a compression spring.
